(19) United States
(12) Patent Application Publication
(10) Pub. No.: US 2004/0258888 A1
(43) Pub. Date: Dec. 23, 2004

(54) Method of manufacturing a composite vehicle body part, a composite part, and a foil for a composite part

(76) Inventors: Matthias Ludwig, Vechelde (DE); Marcus Lutz, Gifhorn (DE); Frank Niebuhr, Wilsche (DE)

Correspondence Address: CARLSON, GASKEY & OLDS, P.C., 400 WEST MAPLE ROAD, SUITE 350, BIRMINGHAM, MI, 48009, US

(21) Appl. No.: 10/874,027

(22) Filed: Jun. 22, 2004

(30) Foreign Application Priority Data
Jun. 23, 2003 (DE) 103 28 046.4

(51) Int. Cl. B32B 3/00

(52) U.S. Cl. 428/158; 428/156; 428/172

(57) ABSTRACT

A method of manufacturing a composite vehicle body part includes producing an embossed portion on a foil in the part via plastic deformation. The embossed portion is formed by pressing the foil against a thin, detachable decoration negative in a deep-drawing tool or a foaming tool. The embossed portion remains visible even after a foam backing or injection-molded backing is provided on the foil.

### REFERENCE TO RELATED APPLICATIONS

The present invention claims the benefit of German Patent Application No. 103 28 046.4, filed Jun. 23, 2003.

### TECHNICAL FIELD

The present invention relates to a method of manufacturing a composite part, such as an add-on vehicle body part. The present invention also relates to a method of manufacturing a foil to be used in a composite part.

### BACKGROUND OF THE INVENTION

Vehicle parts made as composite parts are known in the art. Composite parts are often used in vehicle interiors and as add-on vehicle body parts or panels. Possible uses for composite parts include, for example, roof modules, vehicle flaps (e.g., engine hood, trunk lid, gas tank cover, etc.), bumpers, and fenders. When fitted to a vehicle frame, the composite part may define at least a portion of an outer skin of the vehicle. Composite parts are often made with a thermoplastic or metal foil substrate, which is plastically deformed in a deep-drawing process, and a foamed or injection-molded backing.

There is currently an increasing demand for customized surface designs on vehicle parts. Currently known methods include applying advertising space, large-surface logos of the automotive manufacturer or parts supplier, or other design elements to the composite part after the composite part is manufactured. Possible application methods include applying paint and/or adhesive films to the composite part, but these methods are so common that they often do not create the desired high visual impact.

There is a desire for a method that provides a simpler way to apply a surface design having a high-quality visual appearance to a vehicle body part.

### SUMMARY OF THE INVENTION

A method according to one example of the invention includes positioning at least one decoration negative to an inner wall of a tool. A foil is plastically deformed within the tool by pressing the foil against the inner wall and the decoration negative. The decoration negative leaves a complementary, permanent embossed portion in the foil. A foamed or injection-molded backing may then disposed on one side of the foil.

The inventive method creates a foil with an embossed decoration having a discrete height difference from the remainder of the foil. The embossing creates a visual impression of a very high quality part. Currently, it is impossible to create embossed decorations on vehicle parts, especially on add-on body parts made of sheet metal, because individual customized designs in the form of minimal depressions in the part are extremely expensive. In fact, currently known tools used for deep drawing metal foil do not permit customized designs. By contrast, the decoration created by the invention can have any desired appearance and can be, for example, an embossed pattern, figure, number or letter defined or reproduced by a protrusion, dimple, or depression.

### BRIEF DESCRIPTION OF THE DRAWINGS

Further features and advantages of the invention will be apparent from the following description and from the accompanying drawings to which reference is made and in which:

FIGS. 1 through 3B are cross-sectional views of different steps of a method in accordance with one embodiment of the invention; and

FIG. 4 shows a top view of a composite part produced by the method in accordance with one embodiment of the invention.

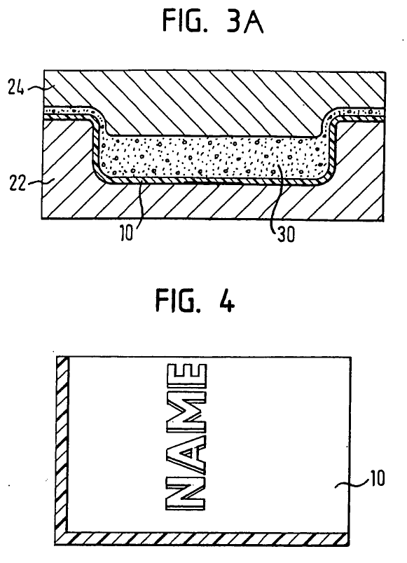

### DETAILED DESCRIPTION OF THE PREFERRED EMBODIMENT

The invention is generally directed to a method that forms an embossed foil for a composite part. The method includes positioning at least one thin decoration negative to an inner wall of a tool and plastically deforming the foil within the tool by pressing the foil against the inner wall and the decoration negative. The decoration negative leaves a complementary, permanent embossed design in the foil. A foamed or injection-molded backing is then disposed on one side of the foil to complete the composite part.

When using a thermoplastic foil or metal foil in the composite part, the decoration may be customized in a very simple fashion because the decoration negative is thin and projects from the inner wall of the tool. The thin profile of the decoration negative makes it relatively inexpensive to manufacture even if the decoration negative covers a large surface. The decoration negative may, for example, be cut via a laser from a metal having the thickness of a relatively thin foil. Once cut, the decoration negative can be simply placed into the tool to manufacture a customized composite part, then removed from the tool when the part is complete. Thus, the same tool can be used to manufacture customized parts with different designs and/or non-customized parts, with virtually no retooling or modification.

The decoration negative creates a permanent embossed portion in the foil. When the embossed portion is produced in a deep-drawing tool before the foam backing or injection-molded backing is applied to the foil, this embossed portion will not be flattened from the foaming or injection pressure created in the tool during application of the backing. It is also possible to generate the embossed portion at the same time as, rather than before, the foamed or injection-molded backing is applied. This is because the foaming or injection pressure may be high enough (on the order of 8 bar) to press the foil against the inner wall and the decoration negative to create the permanent embossed portion in the foil.

In one embodiment, the decoration negative has a maximum thickness that is around 75% of the foil thickness. Moreover, the decoration negative is preferably made from a metal foil containing, for example, aluminum or iron.

In one embodiment, the backing in the composite part is made of foamed or injection molded polyurethane, which may be reinforced with fibers that are added via a long fiber injection method.

If the foil is to be deep-drawn and embossed at the same time, it is not necessary to provide an indentation or projection that is complementary to the embossed portion in the foil to support the foil in a subsequently-used foaming or injection tool. As a result, the only expenditures required for manufacturing the customized composite part are incurred in producing the decoration negative and in positioning the decoration negative in the deep-drawing tool.

The decoration negative may be positioned and secured in the tool by, for example, magnetic force. The decoration negative may also be attached in the inner wall by an appropriate adhesive that allows the decoration negative to be removed from the inner wall without leaving a residue.

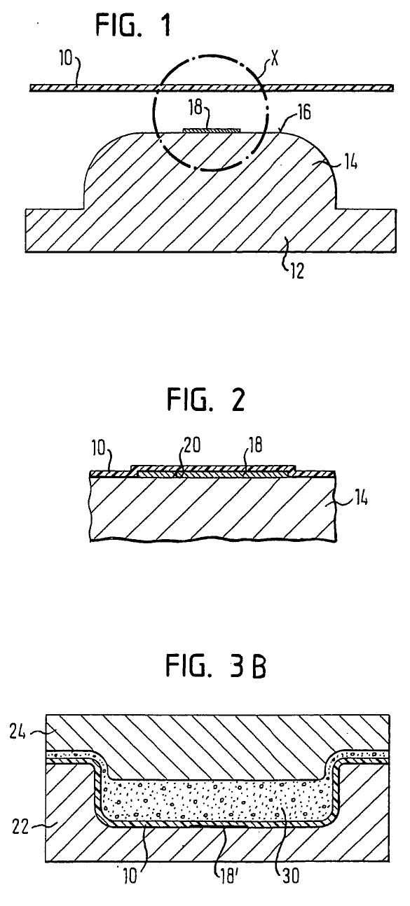

Referring to the figures, FIG. 1 illustrates a planar foil 10 having a thickness of, for example, between 0.5 and 2 mm. The foil 10 may be made of metal or a thermoplastic material. The foil 10 may be configured as a single-layer or multi-layer foil. If the foil is made of plastic, the foil may be dyed throughout.

The foil 10 is positioned and held in place in a deep-drawing tool by, for example, clamping several sections of the edges of the foil 10 to the deep-drawing tool. A die 12 of the deep-drawing tool has a raised portion 14 defined by a substantially flat, non-stepped inner wall 16. The non-stepped inner wall 16 has a large planar surface that contacts the foil 10. The decoration negative 18, which is in the form of at least one part that is separate from the deep-drawing tool, is placed on the inner wall 16 and releasably secured to the die 12 of the deep-drawing tool.

In one embodiment, the decoration negative 18 is a laser-cut metal foil having a maximum thickness of 1 mm, and preferably a thickness of only 0.5 mm.

FIG. 2 is an enlarged view of an area denoted by X in FIG. 1 and shows the contact between the foil 10 and the die 12. As shown in FIG. 2, the die 12 then deforms the foil 10 via high pressure applied to the foil 10. The die 12 may also be heated to aid deformation of the foil 10, particularly if the foil is made of a thermoplastic material. The decoration negative 18 ensures that a permanent embossed portion 20 is produced in the foil 10 during the deep-drawing process. The embossed portion 20 is complementary to the decoration negative 18 and has a corresponding raised portion produced on the opposite side of the foil 10.

As shown in FIG. 2, the embossed portion 20 is complementary to the decoration negative 18. The embossed portion has a depressed portion on one side of the foil 10 and a corresponding raised portion on the other side. In the deep-drawing process, the inner wall 16 and the decoration negative 18 contact the foil 10 across the surface of the foil 10. To ensure high visual quality of the embossed portion 20, the foil 10 has a thickness comparable to the thickness of the decoration negative 18. In one embodiment, the decoration negative 18 has a maximum thickness of 75% of the thickness of the deep-drawn foil 10.

As shown in FIG. 3A, after the foil 10 is deformed, the deep-drawn foil 10 is removed from the deep-drawing tool and placed inside a foaming tool, with the raised portion of the embossed portion 20 facing outward. The foaming tool has a lower part 22 and an upper part 24. The deep-drawn foil 10, which is trough-shaped in this example, is placed into the lower part 22. The lower part 22 has a continuous, planar inner side surface in the area of the raised portion of the embossed portion. Note that the inner side of the lower part 22 does not need to have any depression or other modified configuration for adapting to the embossed portion 20 in the foil 10.

Next, liquid plastic, such as liquid polyurethane, is applied onto the rear side of the foil 10. This application may be performed using, for example, a structural reaction injection molding (S-RIM) method or, if the plastic is fiber-reinforced, a long fiber injection (LFI) method. The upper part 24 of the foaming tool is then moved downward so that the liquid plastic can react and expand to fill the foaming tool with foam. The final result is a composite part made up of the foil 10 and the foamed backing 30.

The composite part may be an add-on vehicle body part, such as a vehicle roof module, in which the embossed portion 20 forms a raised decoration that is visible from the outside of the vehicle. The decoration creates a more valuable, higher quality appearance to the composite part, much like a watermark.

It should be emphasized that the embossed portion 20 does not necessarily need to be raised. It may also be designed in the form of a depression either by providing the foil with a foam backing on the raised side of the embossed portion 20 or by placing a larger-surface decoration negative having individual, spaced raised portions into the tool to form depressed areas between the raised portions on the foil 10. Regardless of the specific configuration of the embossed portion 20, the embossed portion 20 generally has areas with planes that are different than a plane of the remainder of the foil 10.

FIG. 3B illustrates a method according to another embodiment of the invention. In this example, the embossed portion 20 is formed in the foil 10 during the foaming process rather than in the deep drawing process. The foil 10 may undergo the deep-drawing process before being inserted into the foaming tool, but this is not necessary. As shown in FIG. 3, the decoration negative 18′ is releasably secured to the inner side of the lower part 22 of the foaming tool. The pressure generated in the foaming tool during the foaming process ensures that the foil 10 is deformed by the decoration negative 18′, creating the embossed portion 20 in the portion of the foil 10 that contacts the decoration negative 18′. It may even be possible to achieve plastic deformation of the entire foil 10 through pressure in the foaming tool, if desired.

Both of the examples described above can, of course, be modified to form the composite part with an injection-molded backing. In this case, a liquid plastic material is injected into a cavity formed by the lower part 22 and the upper part 24 of a molding tool (similar to the foaming tool shown in FIGS. 3A and 3B) when the molding tool is closed. In this case, reference numeral 30 denotes the injection-molded backing.

It should be understood that various alternatives to the embodiments of the invention described herein may be employed in practicing the invention. It is intended that the following claims define the scope of the invention and that the method and apparatus within the scope of these claims and their equivalents be covered thereby.

1. A method of manufacturing a composite part for a vehicle, comprising:
positioning at least one decoration negative on an inner wall of a tool;
pressing a foil against the inner wall and the decoration negative to plastically deform the foil, wherein the decoration negative leaves an embossed portion in the foil due to the pressing step; and
applying a backing layer to the foil.

2. The method according to claim 1, wherein the decoration negative has a maximum thickness of about 75% of a thickness of the foil.

3. The method according to claim 1, wherein the decoration negative is formed from a metal foil.

4. The method according to claim 1, wherein the decoration negative is produced by laser cutting.

5. The method according to claim 1, wherein the step of applying the backing layer comprises depositing liquid plastic onto the foil via a method selected from the group consisting of foaming and injection molding.

6. The method according to claim 5, wherein the liquid plastic is fiber-reinforced.

7. The method according to claim 1, wherein the decoration negative is positioned in a deep-drawing tool in the positioning step, and wherein the pressing step is conducted in the deep-drawing tool and comprises deep-drawing the foil in the deep-drawing tool to form the embossed portion.

8. The method according to claim 7, further comprising placing the foil in a foaming tool after the pressing step, and wherein the applying step comprises reacting and expanding the liquid plastic to form a foamed layer as the backing layer.

9. The method according to claim 8, wherein the foaming tool lacks a modified surface configuration corresponding to the embossed portion of the foil.

10. The method according to claim 1, wherein the positioning step comprises positioning the foil in a foaming tool, and wherein the pressing step and the applying step are conducted substantially simultaneously by applying a foamed layer as the backing layer, wherein a foaming pressure generated when the foamed layer is applied presses the foil against the decoration negative to form the embossed portion.

11. The method according to claim 10, further comprising deep-drawing the foil before the step of positioning the foil in the foaming tool.

12. A composite part for a vehicle body, comprising:
a foil formed from a material selected from the group consisting of thermoplastic and metal, wherein the foil has an embossed portion where the foil was plastically deformed by a decoration negative; and
a backing layer disposed on the foil formed from at least one of a foamed plastic and an injection molded plastic.

13. A method of manufacturing a composite part for a vehicle body, comprising:
positioning at least one decoration negative on an inner wall of a tool; and
pressing a foil against the inner wall and the decoration negative to plastically deform the foil, wherein the decoration negative leaves an embossed portion in the foil due to the pressing step.

14. The method according to claim 13, wherein the decoration negative has a maximum thickness of about 75% of a thickness of the foil.

15. The method according to claim 13, wherein the decoration negative is formed from a metal foil.

16. The method according to claim 13, wherein the decoration negative is produced by laser cutting.

17. The method according to claim 13, further comprising the step of deep-drawing the foil to plastically deform the foil.

18. A foil for a composite part of a vehicle body, comprising:
a main portion generally extending in a first plane; and
an embossed portion, wherein the embossed portion includes at least one of an indentation and a raised portion defining at least one second plane that is different from the first plane of the main portion.
